(19) United States
(12) Patent Application Publication
(10) Pub. No.: US 2011/0153982 A1
(43) Pub. Date: Jun. 23, 2011

(54) SYSTEMS AND METHODS FOR COLLECTING DATA FROM MULTIPLE CORE PROCESSORS

(75) Inventor: Craig Partridge, East Lansing, MI (US)

(73) Assignee: BBN TECHNOLOGIES CORP., Cambridge, MA (US)

(21) Appl. No.: 12/643,317

(22) Filed: Dec. 21, 2009

(51) Int. Cl. G06F 9/44; G06F 15/76

(52) U.S. Cl. 712/16; 712/220

(57) ABSTRACT

Systems and methods are disclosed for collecting data from cores of a multi-core processor using collection packets. A collection packet can traverse through cores of the multi-core processor while accumulating requested data. Upon completing the accumulation of the requested data from all required cores, the collection packet can be transmitted to a system operator for system maintenance and/or monitoring.

### BACKGROUND OF THE DISCLOSURE

This application relates to collecting data from multiple core (multi-core) processors.

In many cases, in order to effectively manage a network, a systems operator may need to query status information from elements within the network. Increasingly, network devices within networks, such as routers and switches, include multi-core processors because of their superior processing performance. However, the use of multi-core processors can create challenges for systems operators attempting acquire status information necessary to manage the network. For example, status information can be stored across multiple cores of a multi-core processor. Currently, system operators send status requests to each core of a multi-core processor in a network device individually. This can cause increased latency at the queried network device because of the increased number of status information packets being communicated to the systems operator. Additionally, communication going into and out of a multi-core processor chip can be a time consuming process because chip interfaces are relatively slow compared to communications among elements within the chip. Therefore, current systems are ineffective at gathering data from network devices with multi-core processors.

### SUMMARY OF THE DISCLOSURE

To address the deficiencies of the prior art, the disclosure relates to gathering data from multi-core processors using collection packets. As noted above, current systems send data or status requests to each core of a multi-core processor individually. This can increase latency at the queried device. The negative effects of a multi-core processor data acquisition can be mitigated by utilizing collection packets. A collection packet can be sent to the queried processor, traverse each core in the processor, aggregate data from each core into the collection packet, and then sent to a system operator for analysis. By aggregating the data from each core into a single communication into and out of the multi-core processor the negative effects of multi-core processor data acquisition are mitigated.

Methods, systems, and computer readable medium storing computer executable instructions for extracting information from cores of a multi-core processor are disclosed. The multi-core processor can be, for example, part of a network device. The information extraction is initiated by a request from a data collection element to begin collection of core data from the multi-core processor. In some embodiments, the request is analyzed and is determined to be a collection packet. In alternative embodiments, the request from the data collection element can include instructions to create a collection packet upon receipt at the multi-core processor. In some embodiments, the request includes instructions regarding a data collection path of a collection packet through the queried multi-core processor. A first collection instruction is delivered to a first core in the processor and core data from the first core is extracted in response to receiving the first instruction. In some embodiments, the first core is configured to create the first collection instruction in response to receiving the request from the data collection element.

A second collection instruction is passed from the first core to a second core and core data from the second core is extracted in response to receiving the second instruction. In some embodiments, the first and the second core are adjacent. The core data from the first and second cores are accumulated and then transmitted back to the data collection element. In some embodiments, core data will be extracted from some or all of the remaining cores in processor and accumulated with data from the first and second cores before being transmitted to the data collection element. Core data can refer to, for example, packet counter values that are associated with a number of previously received packets that were processed by a respective core. In some embodiments, the accumulated data is transmitted back to the data collection element in the form of a collection packet.

In some embodiments, accumulating the core data entails combining core data values associated with each of the respective cores. Herein, adding, accumulating, and/or combining data can refer to any suitable method of combining, adding, subtracting, multiplying, dividing, concatenating, mixing, matching, averaging, correlating, or any other suitable method to store and/or represent data from one or more source in any suitable location, for example, a packet. In some embodiments, a packet with accumulated data also includes the second collection instruction. In some embodiments, the packet is divided into a header and a data section. In such an embodiment, the second collection instruction can be included in the header section.

According to an embodiment, the second collection instruction that is passed from the first core to the second core includes the core data extracted from the first core. In some embodiments, the first collection instruction is the request from the data collection element. In alternative embodiments, the first collection instruction will be generated based on the request from the data collection element, when the request is received.

In some embodiments, the second collection instruction is passed to the second core in response to determining that the second core contains data that was requested by the data collection element. Additionally or alternatively, a third collection instruction can be passed to a third core at substantially the same time as the first core passes the second collection instruction to the second core. This can allow data collection to occur at two or more cores at substantially the same time. In such embodiments, results from the second and third collection instructions can be accumulated.

In some embodiments, core data is stored in a memory after the core data is extracted from a respective core when carrying out a collection instruction. For example, core data from each respective core can be stored in memory locations associated with the respective cores. Core data that is stored in the memory can be accumulated. For example, the core data stored in memory locations associated with respective cores is accumulated. In some embodiments, accumulated core data is stored in a specified memory location and core data extracted from a core is added to core data previously accumulated and stored in memory.

### BRIEF DESCRIPTION OF THE DRAWINGS

The system and methods may be better understood from the following illustrative description with references to the following drawings in which:

FIG. 1 is a block diagram of a network that includes a network device and a system operator, according to an illustrative embodiment.

FIG. 2 is a schematic diagram of a collection packet, according to an illustrative embodiment.

FIG. 3 is a block diagram of a multi-core processor in a mesh configuration, according to an illustrative embodiment.

FIG. 4 is a schematic diagram of a collection packet path through a multi-core processor in a mesh configuration, according to an illustrative embodiment.

FIG. 5 is a flow chart of a method for gathering core data from cores of a multi-core processor using a collection packet, according to an illustrative embodiment.

FIG. 6 is a schematic diagram of a collection packet path through a multi-core processor in a mesh configuration, according to an illustrative embodiment.

FIG. 7 is a flow chart of a method for gathering core data from cores of a multi-core processor using a collection packet and a memory, according to an illustrative embodiment.

FIG. 8 is a block diagram of a multi-core processor in a master/slave configuration, according to an illustrative embodiment.

FIG. 9 is a schematic diagram of a collection packet path through a multi-core processor in a master/slave configuration, according to an illustrative embodiment.

FIG. 10 is a flow chart of a method for gathering core data from multiple cores of a multi-core processor substantially simultaneously, according to an illustrative embodiment.

### DETAILED DESCRIPTION

To provide an overall understanding of the invention, certain illustrative embodiments will now be described, including systems and methods for collecting data from multi-core processors. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

As described above, the use of multi-core processors in network devices creates challenges to systems operators attempting to acquire information from network devices with multi-core processors. For example, the increased number of status packets being communicated from the network devices can increase latency in the network. This may be partially due to the fact that processor chip interfaces are relatively slow compared to communications among elements within the chip, making multiple independent queries to a chip inefficient. As such, there is a need to increase the efficiency of acquiring information from network devices with multi-core processors.

The methods and systems described herein address the current deficiencies in acquiring information from devices with multi-core processors. For example, the methods and systems described herein attempt to reduce the number of data acquisition communications traversing chip interfaces by aggregating requests for data from multiple cores and responses to such requests into single transmissions to and from multi-core devices.

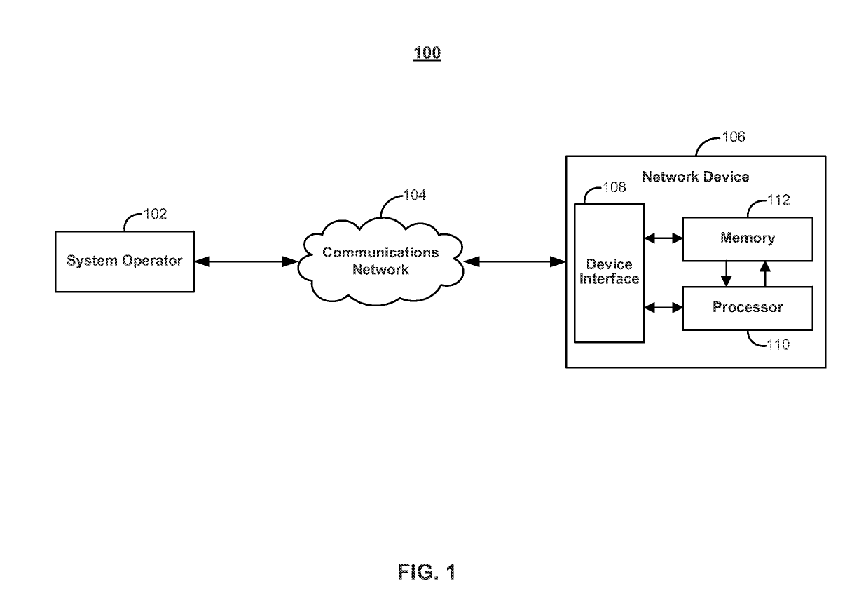

FIG. 1 is a block diagram of network 100 that includes a network element with a multi-core processor. Network 100 includes system operator 102, communications network 104, and network device 106.

System operator 102 is generally responsible for monitoring and maintaining the operation of at least a portion of network 100. For example, operator 102 gathers information regarding latency or processing loads from devices within network 100, such as network device 106. In some embodiments, operator 102 gathers any other suitable information pertaining to the operation, administration, maintenance, and provisioning of network 100. This may include, for example, information pertaining to frequency allocation, traffic routing, load balancing, cryptographic key distribution, configuration information, fault information, security information, performance information, or any other suitable information. System operator 102 gathers information using any suitable method or protocol, for example, Simple Network Management Protocol (SNMP), command-line interface, Common Management Information Protocol (CMIP), Windows Management Instrumentation (WMI), transaction languages, Common Object Request Broker Architecture (CORBA), NETCONF, and Java Management Extensions (JMX).

System operator 102 is coupled with at least one device in network 100, for example, network device 106. Operator 102 can communicate with coupled devices via communications network 104. Communications network 104 is any suitable network or combination of networks that allow operator 102 to communicate with devices in network 100. For example, communications network 104 may be one or more networks including the Internet, a mobile phone network, mobile device network, cable network, public switched telephone network, local area network, personal area network, campus area network, metropolitan area network, or any other suitable type of communications network, or suitable combinations of communications networks.

Network device 106 is a device that resides in network 100 and is coupled to system operator 102 via communications network 104. Device 106 includes device interface 108, memory 112, and processor 110. Interface 108 allows information to pass into or out of device 106. For example, when a packet of information originating from within device 106 is to be communicated to system operator 102, the packet will traverse interface 108. A packet herein refers to any suitable group of data (e.g., two or more bits of information) that is being communicated between devices and/or elements within devices. For example, a packet herein can refer to a network packet following a particular communication protocol. A packet can also refer to any data transmitted between elements of a device, for example, data being transmitted from interface 108 to processor 110. As another example, a packet can refer to data being transmitted between cores of a multi-core processor. In some embodiments, such packets of data include headers with information regarding the packet; however, such headers are not necessary. For example, a packet of data being transmitted between cores of a multi-core processor using a bus may not require a header.

Interface 108 transforms information into any suitable form when the information is transmitted or received. For example, interface 108 will modulate the information for transmission across communications network 104. When the information is being transmitted in the form of a packet, interface 108 will add or modify headers as necessary to the packet so, for example, the packet will be transmitted to its destination correctly. Conversely, interface 108 will demodulate information when it is received over communications network 104. When information is received by device 106, interface 108 will analyze the information to determine the appropriate element within device 106 for which to send the information. For example, interface 108 can pass information received from communications network 104 to processor 110 and/or memory 112. In some embodiments, interface 108 will transform information that is received by or transmitted from device 106 into any suitable form so that the information can traverse communications network 104 correctly and be utilized by any appropriate device in network 100 or any appropriate element within device 106. Interface 108 will communicate the transformed information to any suitable element in device 106 or any suitable device in network 100, as appropriate.

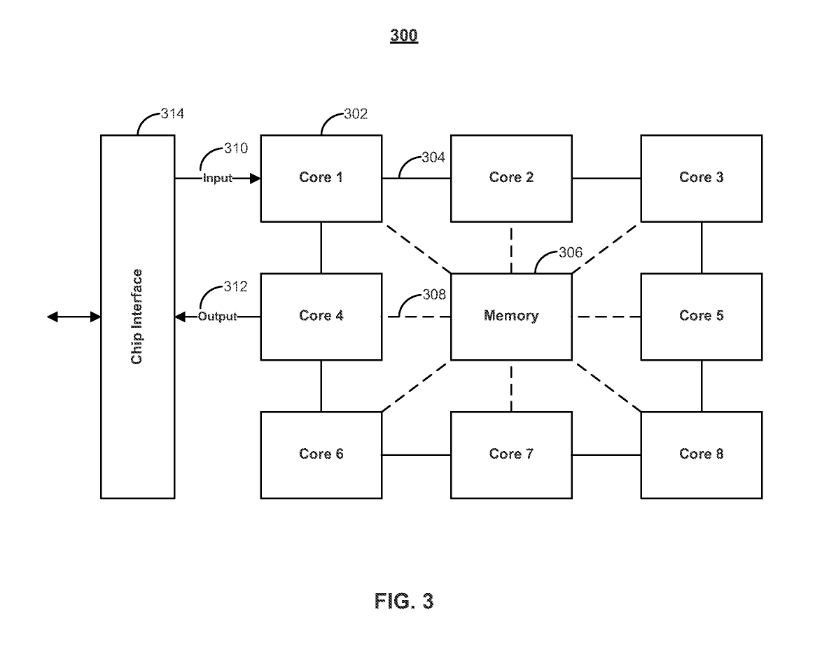

Network device 106 includes processor 110. Processor 110 is capable of processing any suitable information. For example, processor 110 can process information received from device interface 108 or memory 112. In a preferred embodiment, processor 110 is a multi-core processor, such as the Athlon 64 developed by AMD, Core i7 developed by Intel, PC200 developed by picoChip, or AsAP developed by University of California, Davis. Multi-core herein refers to any suitable type processor or processors that include a plurality of sub-processing unit cores. For example, multi-core can refer to a processor with multiple sub-processing unit cores that are manufactured on the same integrated circuit die. Multi-core can additionally or alternatively refer to a processor with multiple sub-processing unit dies manufactured in the same package, or multiple processing units in different packaging within the same device. For example, processor 110 can contain a plurality of processing cores in any suitable configuration, such as a mesh configuration or a master/slave configuration. Some possible configurations are depicted further detail below with regard to FIGS. 3-10.

In some embodiments, processor 110 stores information related processing and/or maintenance status. This may include, for example, information pertaining to frequency allocation, traffic routing, load balancing, cryptographic key distribution, configuration information, fault information, security information, performance information, information about packets processed, packets discarded, errors detected in packets (e.g., incorrect cyclic redundancy checks or checksums), errors detected within device 106 (e.g., memory exhaustion or communication disruptions between elements of device 106), or any other suitable information. For example, processor 110 can store counters that represent the number of packets that have been processed by processor 110 over a particular period of time. When processor 110 is multi-core processor, some or all of the cores of the processor will store information relating to their processing and/or maintenance status. For example, each core will store respective counters that represent the number of packets processed by each of the respective cores.

In some embodiments, network device includes memory 112. Memory 112 can be on-chip or off-chip. For example, when memory 112 is on-chip, memory 112 can be in the same encasing or manufactured on the same integrated circuit die as processor 110. Conversely, when memory 112 is off-chip, memory 112 can be in a different encasing or manufactured on a different integrated circuit die than processor 110. Memory 112 can store any suitable information. For example, memory 112 can store information received over communications network 104 by device interface 108 or information that will later be transmitted over communications network 104 by interface 108. Memory 112 can also store information that will be processed by processor 110 or information from processor 110. For example, memory 112 can store processing and/or maintenance information of processor 110, such as, the counters that represent the number of packets that have been processed by a respective core of a plurality of cores, as described above with respect to processor 110.

In an alternative embodiment, network 100 is within a single device. For example, system operator 102, communications network 104, and network device 106 are all elements within a single device. For example, system operator 102 is an element within a device that monitors processing progress for the single device. Communications network 104 is the communication path between elements of the single device. For example, communications network 104 can be a bus between elements of the single device. Processor 110 is a processor of the single device.

In an alternative embodiment, network 100 is a virtual device. For example, network 100 may be a computing cluster that presents itself as a single device to other devices. For example, network 100 may be composed of multiple network devices and multiple communications networks, each of which is operated by a single operating organization. This network 100 may represent itself as a single device when communicating with devices or organizations outside of network 100.

As described above, system operator 102 is responsible for monitoring devices in network 100, which in some cases, will increase latency or decrease the efficiency of a device. This might be due to the fact that queries from operator 102 may require the queried device to perform uncommon, inefficient analysis. For example, device interface 108 of network device 106 will generally perform its main duty fairly efficiently. For example, interface 108 generally processes network packets as its main duty, and therefore processes the packets fairly efficiently. However, when interface 108 encounters a query from operator 102, which is not is not its main duty, interface 108 may be forced to interrupt processing of its main duty to run uncommon and/or inefficient processes to analyze and handle the query. Additionally, processor 110 also includes an interface to communicate with elements in device 106. The interface of processor 110 may have similar problems with efficiency when encountering uncommon requests as interface 108 may have, as discussed above.

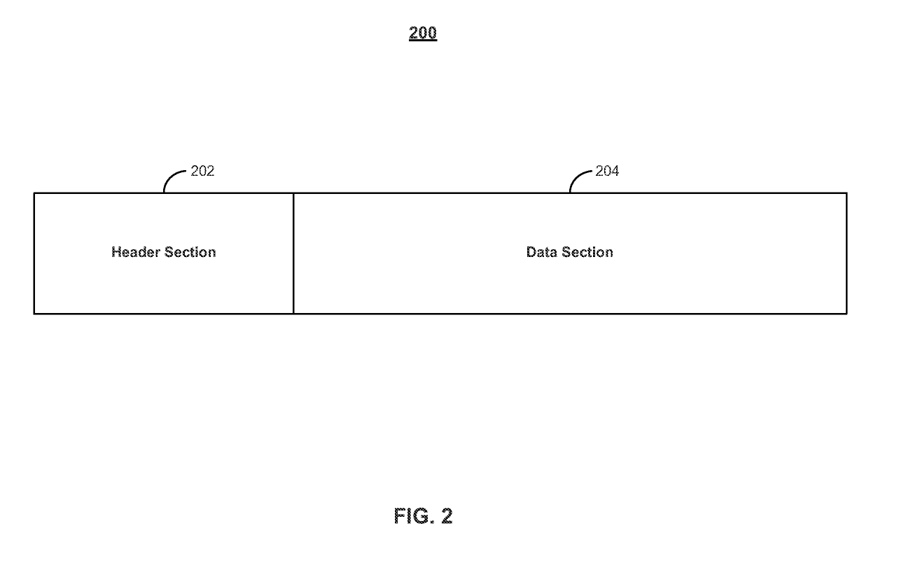

In some embodiments, inefficiencies caused by queries can be avoided by querying devices within network 100 using collection packets, such as collection packet 200 depicted in FIG. 2. For example, collection packet 200 can substantially resemble a normal communications packet, and thus, device interface 108 will not process the packet 200 differently than interface 108 would for any other packet (e.g., interface 108 will not interrupt its normal processing of its main duty to run inefficient processes). Packet 200 includes header section 202 and data section 204. A collection packet herein refers to any suitable packet that contains or is intended to contain data collected from any suitable device and/or element. For example, a collection packet can be any suitable group of data, wherein the data represents information collected from one or more cores of a multi-core processor, such as processor 110 of FIG. 1.

Header section 202 contains any suitable information so that the packet may traverse, for example, communications network 104 of FIG. 1. For example, header section 202 may include information relating to the length of collection packet 200, length of sections within packet 200, time to live, protocol used, checksums, source addresses, destination addresses, communication protocol used, or any other suitable type of information. In some embodiments, header section 202 includes information that notifies network devices that packet 200 is a collection packet. For example, header section 202 will be analyzed by device interface 108 and/or processor 110 of FIG. 1 when packet 200 is received by network device 106 and they will determine that packet 200 is a collection packet. Additionally, header section 202 can contain information regarding what data is being requested by the collection packet. When elements in network device 106 determine packet 200 is a collection packet, processor 110 can add requested data to packet 200 in, for example, data section 204. Herein, adding, accumulating, and/or combining data can refer to any suitable method of combining, adding, subtracting, multiplying, dividing, concatenating, mixing, matching, averaging, correlating, or any other suitable method of storing and/or representing data from one or more source in any suitable location, for example, in a packet.

Data section 204 may contain any suitable information and be of any suitable length. In a preferred embodiment, data section 204 is fixed in length. In alternative embodiments, data section 204 is variable. When packet 200 is a collection packet, network device 106 can add requested data to data section 204. For example, processor 110 will add processor and/or core data to data section 204 for transmission to system operator 102.

In some embodiments, collection packets can be masked as “fake packets.” For example, the fake packet would generally resemble a normal network communication packet. Thus, device interface 108 would not treat the received collection packet differently than it would any other normal communication packet. For example, interface 108 would not enter inefficient processes to process a query as noted above, but instead forward the fake packet to processor 110 as it would any normal packet. When processor 110 receives the fake packet, processor 110 would recognize the fake packet as a collection packet originating from system operator 102 based on, for example, information contained in header section 202. When the fake packet is recognized as a collection packet, processor 110 adds the requested information to the collection packet at, for example data section 204. When the addition of requested information to data section 204 is complete, device 106 transmits the collection packet back to operator 102.

As noted above, processor 110 can be a multi-core processor. The cores of a multi-core type of processor 110 may be in any suitable configuration. For example, cores of a multi-core processor 110 can be in a mesh layout as shown in processor 300 of FIG. 3. In a mesh layout, no one core exerts substantially more control in processor 300 than any other core. For example, there is no master core. Processor 300 includes cores 302, core-to-core paths 304, memory 306, core-to-memory paths 308, input 310, output 312, and chip interface 314.

Processor 300 can include any number of cores 302. Cores 302 represent every core in processor 300. Cores 302 may be of any suitable type, configuration, and may include any suitable elements to aid in processing operations. For example, cores 302 may include one or more of buffers, memories, caches, clocks, arithmetic logic units, configuration hardware and/or software, or any other suitable element. Elements in cores 302 may be of any suitable size, shape, and complexity. Cores 302 may be homogeneous (e.g., each core is identical) or heterogeneous (e.g., one or more cores are different than the other cores in processor 300). In some embodiments, one or more of cores 302 maintains information pertaining to frequency allocation, traffic routing, load balancing, cryptographic key distribution, configuration information, fault information, security information, performance information, or any other suitable information for maintenance and/or monitoring purposes. For example, cores 302 can maintain counters indicative of the number of data packets processed by a respective core of cores 302. In some embodiments, this information can be gathered and/or computed by cores 302 and stored and/or updated in memory 306.

Cores 302 include instruction sets to provide cores 302 with the necessary instructions to carry out any necessary process. The instructions sets can be embedded in cores 302 in any suitable method and format. For example, instruction sets can be incorporated into the operating system, firmware, and/or memory of cores 302. For example, the cores of multi-core processors, such as those in multi-core field programmable gate arrays or in the Athlon 64, can contain a compiled configuration of instructions to perform necessary processes. In some embodiments, the instruction sets can be modified locally or remotely as necessary. For example, system operator 102 can send an instruction to network device 106 to modify the instruction sets of cores 302 in any suitable manner. In some embodiments, instruction sets in cores 302 include instructions on how to handle incoming and outgoing communications, for example, communications to and from interface 314 and/or other cores. In some embodiments, the instruction sets will instructions regarding recognizing and processing data collection packets, such as collection packet 200. For example, the instruction set will instruct cores 302 to read headers of received packets, gather core data when the header denotes a received packet as a collection packet, and route the collection packet to a next appropriate device element (e.g., another core of cores 302, interface 314, or interface 108 of FIG. 1).

Cores 302 communicate with each other using core-to-core paths 304. Paths 304 can be coupled to cores 302 in any suitable manner. For example, paths 304 can couple any boundary of core 1 to any boundary of core 2. For example, paths 304 can couple the eastern boundary of core 1 to the western boundary of core 2. Paths 304 can be synchronous or asynchronous connections, may be capable of carrying any suitable form and amount of data, and implemented in any suitable manner. For example, paths 304 can be unidirectional or bidirectional buses.

Processor 300 receives and transmits all information into and out of processor 300 using chip interface 314. Interface 314 provides an interface between elements inside processor 300 (e.g., cores 302) and elements outside processor 300 (e.g., memory 112 of FIG. 1). Information received at interface 314 may be transmitted from any suitable element within, for example, network device 106 of FIG. 1. For example, information may be received at chip interface 314 after device interface 108 receives and processes information received from communications network 104 at network device 106 of FIG. 1. Information received at interface 314 can be any suitable form of information, for example, packets of data.

Interface 314 can be implemented in any suitable hardware and/or software. For example, interface 314 can consist of buffers to hold information until communication paths are clear exiting or entering processor 300. Interface 314 will communicate information received outside of processor 300 to elements inside processor 300 via input 310. Interface 314 will receive information from elements inside processor 300 for transmission outside processor 300 via output 312. For example, a packet of information can be received at interface 314 for passage to core 1 via input 310. In some embodiments, there is a plurality of interfaces 314. For example, there can be a separate interface 314 for each of input 310 and output 312. Interface 314 will hold the packet in its buffers until core 1 is ready to receive the packet.

Input 310 can be coupled to any suitable core or cores in processor 300. Input 310 is the path for information to travel from interface 314 into cores 302. Information received on input 310 can be any suitable form of information, for example, packets of data. Input 310 can be implemented in hardware and/or software in any suitable manner. For example, input 310 can be any suitable bus connecting interface 314 to cores 302.

Output 312 can be coupled to any suitable core or cores in processor 300. In some embodiments, output 312 is coupled to at least one core to which input 310 is coupled. Information transmitted from output 312 may be of any suitable form of information, for example, packets of data. Output 312 can be implemented in hardware and/or software in any suitable manner. For example, output 312 can be any suitable bus connecting cores 302 to interface 314.

In some embodiments, processor 300 includes memory 306. Memory 306 may be any suitable form of memory, for example, random-access memory, read-only memory, flash memory, or any other suitable form of memory. Memory 306 may be of any suitable size. Memory 306 is accessed by cores 302 via core-to-memory paths 308. Paths 308 can be any suitable synchronous, asynchronous, unidirectional, or bidirectional connection and can be implemented in any suitable manner. For example, paths 308 can be unidirectional or bidirectional buses. Cores 302 can access information and/or write information to memory 306 in any suitable manner.

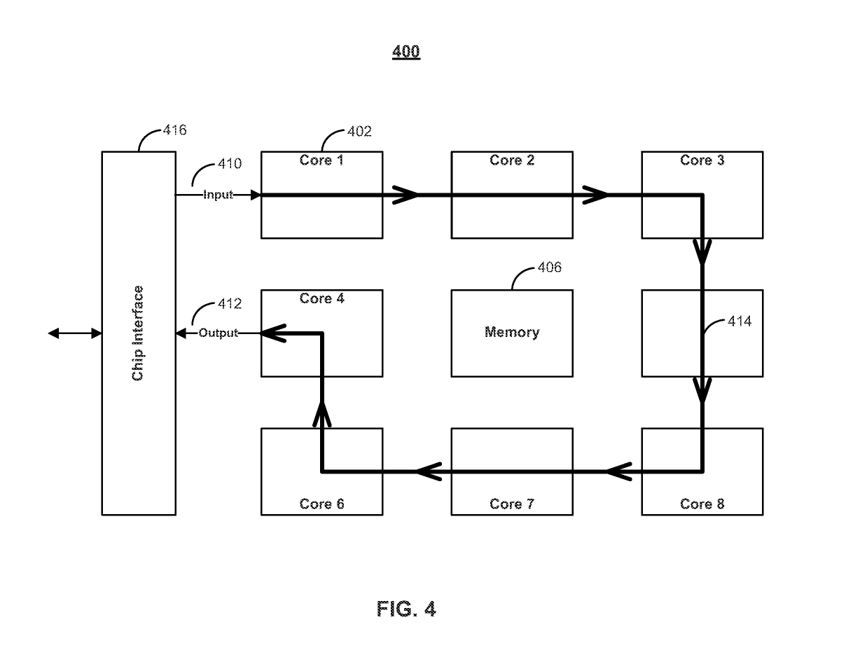

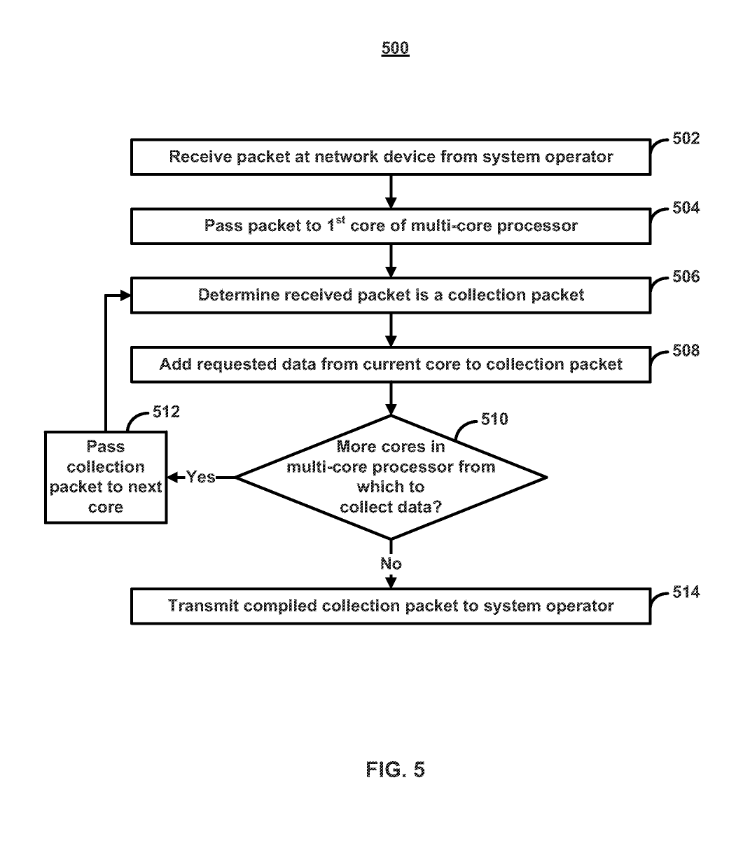

As described above, processor 110 of FIG. 1 can be queried for maintenance and/or monitoring information using collection packets, such as collection packet 200 of FIG. 2. FIG. 5 shows illustrative process 500 for querying maintenance and/or monitoring information from cores of multi-core processor 400 of FIG. 4 using collection packets. Processor 400 is substantially similar to processor 300 of FIG. 3 and may be used instead of or in addition to processor 110 in network device 106. Processor 400 includes cores 402, memory 406, input 410, output 412, collection packet path 414, and chip interface 416. Cores 402, memory 406, input 410, output 412, and chip interface 416 are substantially similar to cores 302, memory 306, input 310, output 312, and chip interface 314 of FIG. 3, respectively.

At step 502, a packet is received at a network device from a system operator. The system operator is substantially similar to system operator 102 of FIG. 1. In some embodiments, the system operator is aware that it is querying a multi-core processor. In such embodiments, the system operator can adapt the type of query. For example, the system operator can query the network device using a collection packet that is associated with specific instructions to query cores of the multi-core processor. Alternatively, the system operator is agnostic as to whether the processor in the queried network device has a multi-core processor. In such an embodiment, the system operator can query the network device using any method, however, when the network device receives the query, the device can create a collection packet to query the cores of the multi-core processor.

At step 504, the packet is passed to the first core of multi-core processor 400 using input 410, which for illustrative purposes is coupled to core 1 of cores 402. At step 506, the collection packet arrives at core 1 and core 1 identifies the packet as a collection packet. Further, core 1 identifies what information is being requested by operator 102. For example, an instruction set embedded in core 1 provides core 1 with instructions to determine whether a received packet is a collection packet. For example, the instructions can instruct core 1 to identify the received packet as a collection packet when the header section of the packet contains a particular bit pattern. Once core 1 determines that the received packet is a collection packet, the instructions can instruct core 1 to analyze the packet to determine what information is being requested. For example, the header section of the packet will contain set flags that denote that packet counter information is being requested.

In an alternative embodiment, the determination that the packet is a collection packet is made at chip interface 416. In this embodiment, interface 416 can send a signal to a core or multiple cores of cores 402 indicating that core data information is being queried and/or what information is being queried. When the packet is determined to be a collection packet, the queried core can interrupt its current process to fulfill the query. Alternatively, the queried core can assign the query a priority and fulfill the query when an appropriate time presents itself. For example, after system critical processes have been handled. In another embodiment, the queried core requests assistance from another core in processor 400 to continue processing a task while the queried core fulfills the query.

When a queried core is ready to fulfill the query, process 500 proceeds to step 508 where the requested data from the query is added from the currently queried core to the data section of the collection packet, for example, data section 204 of FIG. 2. For example, when the core data being requested relates to a packet processing counter, core 1 will add the current value of its packet processing counter to the current value of the data section of the collection packet. In an alternative embodiment, core 1 will amend a specified sub-section of the data section with the requested information, wherein the specified sub-section is dedicated for information associated with core 1. In some embodiments, cores will reset their core data after adding the core data to the collection packet. For example, the packet processing counter of core 1 can be reset to a value of 0 after core 1 adds the current value of its counter to the collection packet. As discussed above, any suitable maintenance and/or monitoring data can be requested by a system operator, and therefore; any suitable maintenance and/or monitoring data can be added to and/or amended into the data section of the collection packet.

After the queried core adds its requested core data information to the packet, the query is considered fulfilled for that core and process 500 proceeds to step 510. At step 510, the core that fulfilled the query determines whether there are more cores in processor 400 from which to collect data. In one embodiment, the current core can determine whether there are more cores from which to collect data by pinging one or more of the other cores in processor 400 to determine whether they have already fulfilled the data collection query. For example, core 1 can ping core 2 to notify core 2 that core 1 has fulfilled its data collection and is ready to pass the collection packet to core 2. When core 2 is ready to receive the data collection packet, core 2 can respond to core 1's ping to assert that core 2 is ready. If core 2 has already satisfied its query, core 2 will notify core 1 as such. Thus, core 1 will know the query status of core 2.

In an alternative embodiment, core 1 can determine whether there are more cores from which to collect data based on information in the collection packet, for example, in the collection packet header sections and/or data sections. For example, the header section of the collection packet can instruct core 1 to pass the collection packet to a specific core or cores after core 1 has added core 1's data to the collection packet. As another example, core 1 can examine the data section of the collection packet to determine whether other cores have added their core data to their respective dedicated sub-sections of the data section of the collection packet. For example, core 1 can examine data sub-section 2, which is associated with core 2. When there is no new core data in data sub-section 2, core 1 can determine that the core 2 has not yet contributed its core data to the collection packet, and thus, the collection packet should be passed to core 2.

In some embodiments, cores can set a flag in the collection packet to indicate that they have fulfilled their query. For example, after core 1 fulfills its query, core 1 will set a flag in the header section of the collection packet to indicate that it has fulfilled its query. Cores queried thereafter can examine the flags in the header section of the collection packet and determine that core 1 has already fulfilled its query.

In some embodiments, cores can determine whether there for more cores from which to collect data based on instructions that are embedded into the software and/or hardware of the cores. For example, directions to follow collection packet path 414 can be embedded as part of the instruction set of the cores. For example, instructions for a data collection process can be incorporated into the instruction sets of the cores and can be executed when a collection packet arrives at the cores. In some embodiments, the instructions for the data collection process will include information regarding path 414. For example, the instructions for data collection process will include instructions for core 1 to pass collection packets to core 2 upon completion of step 508. In some embodiments, path 414 will differ depending on what information is being requested. For example, core 1 will pass collection packets to core 2 when information ‘X’ is being requested; and passed to core 4 when information ‘Y’ is being requested.

When it is determined that there are more cores from which to collect data at step 510, process 500 will proceed to step 512 where the currently queried core will pass the collection packet to the next appropriate core in processor 400. For example, the currently queried core will pass the collection packet to a core it determined had yet to be queried at step 510. After the collection packet is passed to the next appropriate core, process 500 proceeds back to steps 506, 508, and 510 to repeat the collection packet determination, requested core data addition to the collection packet, and determination of whether there are more cores from which to collect data, respectively. For example, the collection packet can follow collection packet path 414 through cores 402 to gather each core's respective core data while repeating steps 506, 508, and 510 as appropriate. When it is determined that there are no other cores in processor 400 from which to collect data, process 500 proceeds to step 514.

At step 514, processor 400 transmits the compiled core data in the collection packet back to the system operator that initiated the query or any other suitable element. Processor 400 can output the collection packet in any suitable form to, for example, device interface 108 and/or memory 112 of FIG. 1 using interface 416. In some embodiments, this may require that the collection packet traverses cores already queried before proceeding to interface 416. For example, the collection packet can return back to core 1 before exiting processor 400 through interface 416. In such an embodiment, the cores receiving the collection packet multiple times can further update the collection packet with changes of their requested core data. For example, if the collection packet returns back to core 1 before exiting processor 400, core 1 can add any changes to its core data to the collection packet before passing the collection packet to interface 416.

In an alternative embodiment, the collection packet is generated within the network device after receiving a separate query message from a system operator. For example, a system operator can ping the network device to notify the network device that the system operator is requesting monitoring and/or maintenance information from the network device's processor, for example, processor 400. In response to receiving the request from the system operator, the network device creates a collection packet to query some or all of the individual cores of processor 400 as described above. Upon query completion of the query using the collection packet, the network device can extract the requested information from the collection packet and send the information to the requesting system operator in any suitable manner.

In practice, one or more stages shown in process 500 may be combined with other stages, performed in any suitable order, performed in parallel (e.g., simultaneously or substantially simultaneously), or removed. For example, cores can add the requested core data to the collection packet at step 506 and determine whether there are more cores in processor 400 from which to collect data at step 510 substantially simultaneously. Process 500 may be implemented using any suitable combination of hardware and/or software in any suitable fashion.

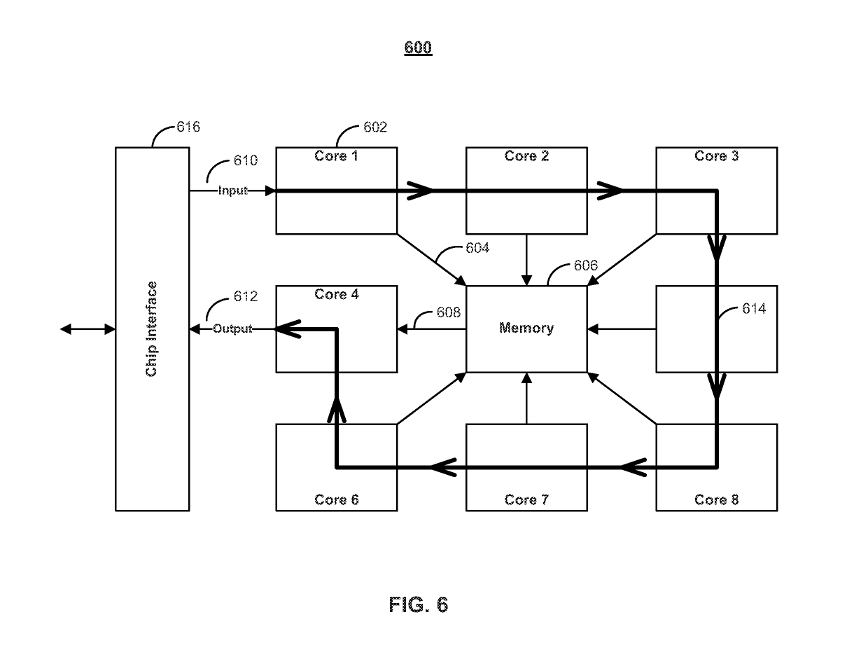

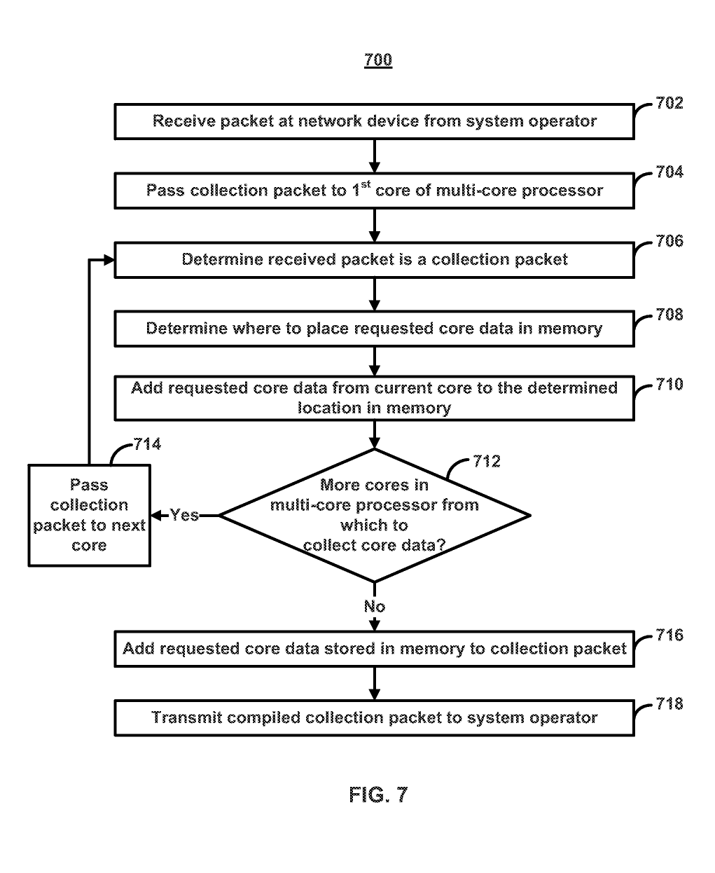

In another embodiment, process 500 can be modified to utilize off-core memories included in multi-core processors when querying a multi-core processor for maintenance and/or monitoring information. FIG. 7 shows illustrative process 700 for querying maintenance and/or monitoring information from cores of multi-core processor 600 of FIG. 6 using collection packets and off-core memories. Processor 600 is substantially similar to processor 400 of FIG. 4 and may be used instead of or in addition to processor 110 in network device 106. Processor 600 includes cores 602, core-to-memory paths 604, memory 606, memory-to-core paths 608, input 610, output 612, collection packet path 614, and chip interface 616. Cores 602, memory 606, input 610, output 612, and chip interface 616 are substantially similar to cores 402, memory 406, input 410, output 412, and chip interface 416 of FIG. 4, respectively.

Steps 702, 704, and 706 are substantially similar to steps 502, 504, and 506 of FIG. 5, respectively. After the received packet is determined to be a collection packet at step 706, process 700 will proceed to step 708. At step 708, the current core determines where to place the core data requested by the collection packet. For example, the header section of the collection packet contains instructions to store the requested data in a specific location in memory 606. In some embodiments, the memory location will be shared by a plurality of cores. In alternate embodiments, the memory location will be dedicated for a single core. In such an embodiment, there can be multiple memory locations for core data storage in memory 606, wherein each location is dedicated to a particular core or cores.

After the memory location core data storage is determined from the collection packet, process 700 proceeds to step 710. At step 710, the current core amends the determined memory location to include the requested core data of the current core. For example, core 1 adds the current value of its packet processing counter to any value in the specified memory location. In some embodiments, other cores have already added their core data to the specified memory location; therefore, the data in the specified memory location will be non-zero. In such an embodiment, core 1 will add its requested data to the existing data in the specified memory location in any suitable manner. Cores 602 can transfer requested core data to memory 606 using core-to-memory paths 604. Paths 604 are substantially similar to paths 308 of FIG. 3.

Once the current core has completed adding the requested core data to the specified memory location, process 700 proceeds to step 712, which is substantially similar to step 510 of FIG. 5. At step 712, the current core determines whether there are more cores in processor 600 from which to collect core data. For example, the current core determines whether the system operator is requesting core data from any other core in processor 600 that has not yet added their data to memory 606. In some embodiments, this determination can be completed as discussed above with regard to step 510. In alternative embodiments, core 1 can make the determination by examining memory 606. For example, when each queried core is to add data to a core specific location in memory 606, core 1 can examine the other core specific locations to determine whether the other cores have already added data to those locations. For example, if core 2 has already been queried, the memory location assigned to core 2 would contain recently added core data. If it does not, core 1 will assume core 2 has yet to be queried.

In some embodiments, memory locations are reinitialized after every query is successfully completed. Additionally or alternatively, timestamps can be used to indicate when the last query was fulfilled by a particular core or group of cores. When timestamps are utilized, for example, core 1 can determine whether the core data in a specified memory location was added to that location during a previous system operator query or during the current query. If a timestamp was added during a previous query, core 1 will determine that the core associated with that memory location has not yet been queried.

In some embodiments, cores can set a flag in a suitable location in memory to indicate that they have satisfied their query. For example, after core 1 fulfills its query, core 1 will set a flag in the specified memory location to indicate that it has fulfilled its query. Cores queried thereafter can examine the flags in memory 606 and determine that core 1 has already fulfilled its query.

When it is determined that there are more cores from which to collect data at step 712, process 700 will proceed to step 714 where the currently queried core will pass the collection packet to the next appropriate core in processor 600. For example, the currently queried core will pass the collection packet to a core it determined had yet to be queried at step 712. After the collection packet is passed to the next appropriate core, process 700 proceeds back to steps 706, 708, 710 and 712 to repeat the collection packet determination, memory location determination, requested core data addition to memory, and determination of whether there are more cores from which to collect data, respectively. For example, the collection packet can follow collection packet path 614 through cores 602 to accumulate each core's respective core data in memory while repeating steps 706, 708, 710 and 712 as appropriate. When it is determined that there are no other cores in processor 600 from which to collect data, process 700 proceeds to step 716.

At step 716, core data that had been added to the specified location or locations in memory 606 will be added to the collection packet. For example, the last core to be queried and/or receive the collection packet can access the specified memory location or locations in memory 606 to read the accumulated queried core data. As illustrated in FIG. 6, core 4, which is the last core along collection packet path 614, gathers the accumulated core data from memory 606 via memory-to-core paths 608. Paths 608 are substantially similar to paths 308 of FIG. 3. After gathering the accumulated core data from memory 606, the memory location can be reinitialized, a timestamp, and/or flag can be updated to indicate that the core data was gathered. After gathering the core data from memory at step 716, process 700 proceeds to step 718.

At step 718, processor 600 transmits the compiled core data in the collection packet back to the system operator that initiated the query or any other suitable element. Processor 600 can output the collection packet in any suitable form to, for example, device interface 108 and/or memory 112 of FIG. 1 using output 612.

In some embodiments, elements of process 500 of FIG. 5 and process 700 can be combined in any suitable manner. For example, queried core data can be accumulated in memory 606 for selected cores as described in process 700, while other selected cores accumulate their core data onto the collection packet without using memory 606 as described in process 500. The core data stored in memory 606 and core data accumulated in the collection packet can be combined in any suitable fashion at any appropriate time before being output from processor 600.

In practice, one or more stages shown in process 700 may be combined with other stages, performed in any suitable order, performed in parallel (e.g., simultaneously or substantially simultaneously), or removed. For example, cores can add the requested core data to the specified memory location at step 710 and pass the collection packet to another core at step 714 substantially simultaneously. Process 700 may be implemented using any suitable combination of hardware and/or software in any suitable fashion.

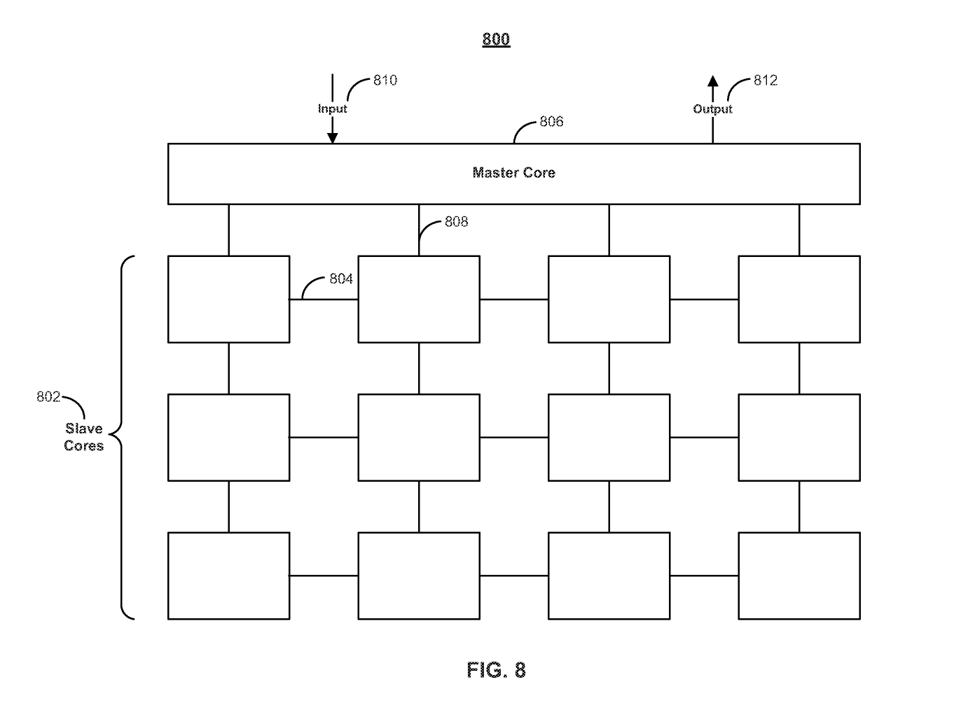

In some embodiments, processor 110 can be a multi-core processor configured in a master/slave layout as shown in processor 800 of FIG. 8. In a master/slave layout, there is a master core or cores that exerts some level of control over a slave core or cores. Processor 800 includes slave cores 802, slave core-to-slave core paths 804, master core 806, master core-to-slave core paths 808, input 810, and output 812.

Slave cores 802 represent every slave core in processor 800. Processor 800 can include any number of slave cores 802. Slave cores 802 are dependent upon master core 806 for operation. For example, slave cores 802 will not perform an operation until instructed to do so by master core 806. In some embodiments, all information processed by slave cores 802 is communicated to slave cores 802 by master core 806. In alternative embodiments, information to be processed by slave cores 802 is communicated to slave cores 802 through input 810, however, slave cores 802 can refrain from processing the information until slave cores 802 receive permission to do so from master core 806. Slave cores 802 may be of any suitable type, configuration, and may include any suitable elements to aid in processing operations. For example, slave cores 802 may include one or more of buffers, memories, caches, clocks, arithmetic logic units, configuration hardware and/or software, or any other suitable element. Elements in slave cores 802 may be of any suitable size, shape, and complexity. Slave cores 802 may be homogeneous (e.g., each slave core is identical) or heterogeneous (e.g., one or more slave cores are different than the other slave cores in processor 800). In a preferred embodiment, one or more of slave cores 802 maintains information pertaining to frequency allocation, traffic routing, load balancing, cryptographic key distribution, configuration information, fault information, security information, performance information, or any other suitable information for maintenance and/or monitoring purposes. For example, slave cores 802 can maintain counters indicative of the number of data packets processed by a respective slave core of slave cores 802. Slave cores 802 can communicate with each other slave core via slave core-to-slave core paths 804. Paths 804 are substantially similar to core-to-core paths 304 and core-to-memory paths 308 of FIG. 3.

Processor 800 can include any suitable number of master cores 806. For illustrative purposes, processor 800 includes a single master core 806 in FIG. 8. In some embodiments, master core 806 is identical to one or more of slave cores 802; however, master core 806 is designated as a master core. As such, master core 806 exerts some level of control over slave cores 802. For example, master core 806 can control work loads, synchronization, operation, or any other attribute of slave cores 802. In some embodiments, the designation of master core is adaptable. For example, the master core designation can change as needed in processor 800. A core previously designated as master core 806 can become one of slave cores 802 when the core previously designated as master core 806 loses its master core designation and a core previously designated as one of slave cores 802 gains a master core designation.

In some embodiments, master core 806 is different from slave cores 802. For example, master core 806 can be implemented with more complex and/or robust hardware and/or software than slave cores 802 to better perform master core duties. In an alternative embodiment, master core 806 is implemented with less complex and/or robust hardware and/or software than slave cores 802. For example, the main duty of master core 806 can be a slave core control process that does not require substantial computation. In such an embodiment, master core 806 would not need to be implemented in a more complex and/or robust manner than slave cores 802. In some embodiments, master core 806 is substantially similar to chip interface 314 of FIG. 3.

Master core 806 can communicate with slave cores 802 via master core-to-slave core paths 808. Paths 808 are substantially similar to core-to-core paths 304 and core-to-memory paths 308 of FIG. 3. In some embodiments master core-to-slave core paths 808 are more or less robust than slave core-to-slave core paths 804 depending on the nature of information traversing paths 808.

Processor 800 includes input 810 and output 812, which are substantially similar to input 310 and output 312, respectively. For illustrative purposes, input 810 and output 812 are shown as being coupled to master core 806, however, input 810 and output 812 can be coupled to any other suitable element in processor 800. For example, input 810 and/or output 812 can be coupled to one or more of slave cores 802.

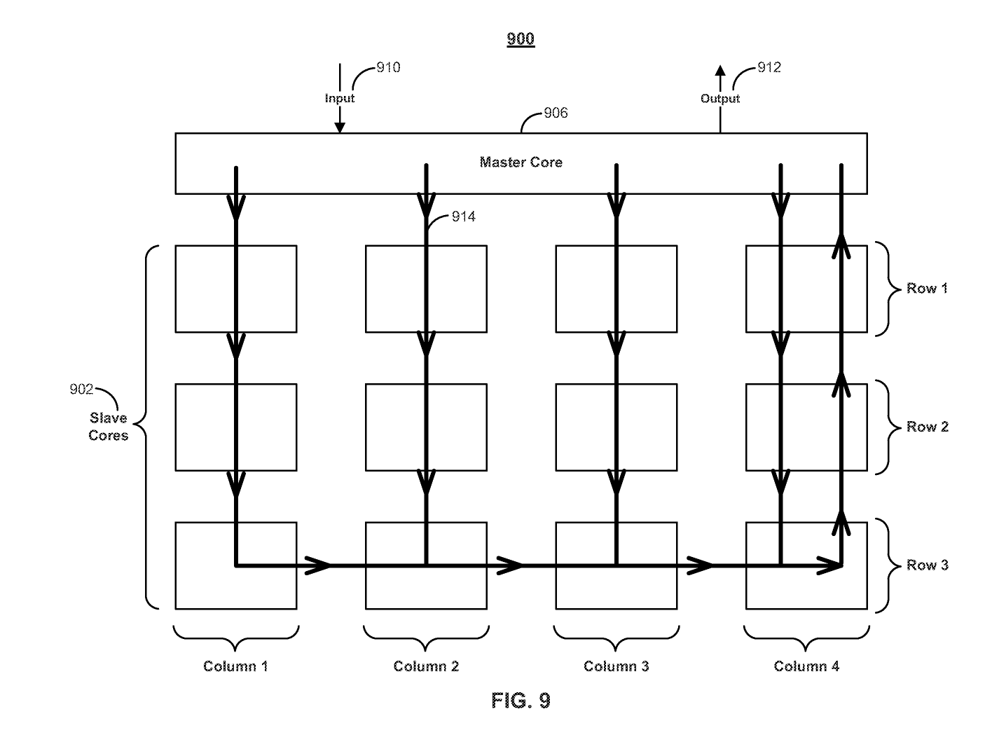

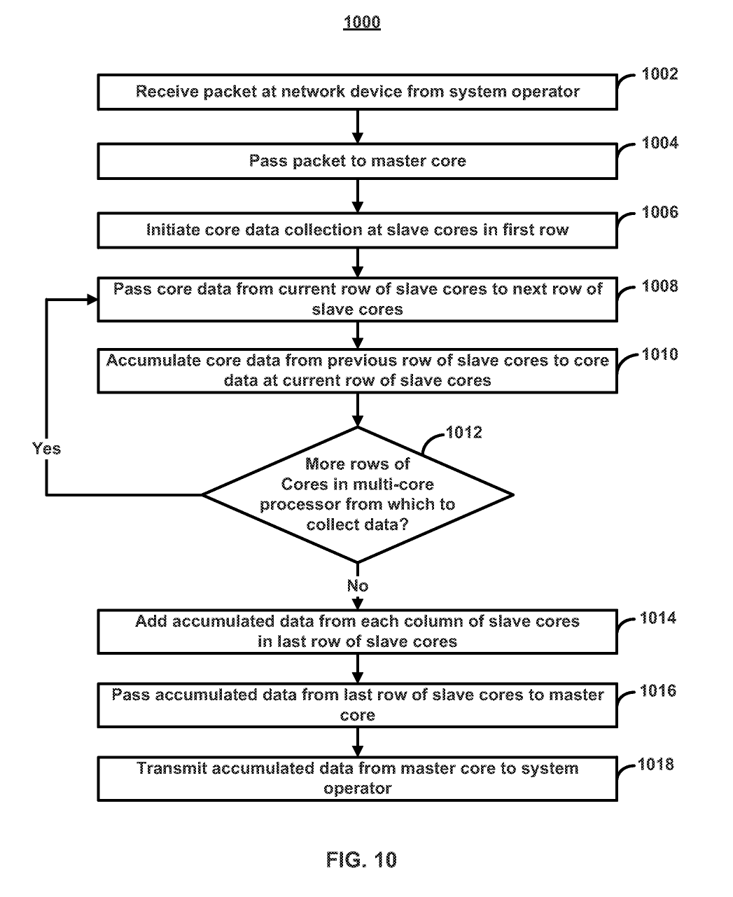

As described above, processor 110 of FIG. 1 can be queried for maintenance and/or monitoring information using collection packets, such as collection packet 200 of FIG. 2. FIG. 10 shows illustrative process 1000 for querying maintenance and/or monitoring information from cores of multi-core processor 900 of FIG. 9 using collection packets. Processor 900 is substantially similar to processor 800 of FIG. 8 and may be used instead of or in addition to processor 110 in network device 106. Processor 900 includes slave cores 902, master core 906, input 910, output 912, and core data path 914. Slave cores 902, master core 906, input 910, and output 912 are substantially similar to slave cores 802, master core 806, input 810, and output 812 of FIG. 8, respectively.

At step 1002, a packet is received at a network device from a system operator, for example, system operator 102 of FIG. 1. At step 1004, the packet is passed to master core 906 using input 910. When master core 906 receives the packet, master core 906 analyzes the packet to determine that the packet is a collection packet. For example, the analyzed packet can be a collection packet requesting maintenance and/or monitoring information from processor 900. Master core 906 can make this determination based on information in the packet header section, for example, header section 202 of FIG. 2. In some embodiments, for example, when input 910 is coupled to one of slave cores 902, a slave core will initially receive the packet. In such an embodiment, the slave core can make the determination that the packet is a collection packet and send the packet to master core 906 and/or other slave cores 902 as appropriate.

After master core 906 determines that the received packet is a collection packet, process 1000 proceeds to step 1006. At step 1006, master core 906 initiates the core data collection at a first row of slave cores 902. For example, master core 906 will pass copies of the collection packet or new collection packets to slave cores immediately adjacent to master core 906. As illustrated in FIG. 9, the collection packets will follow core data path 914 from master core 906 to row 1 of slave cores 902. For example, four copies of the collection packet will be made and transmitted to each slave core in row 1 of slave cores 902. In some embodiments, the copies of the collection packet will be transmitted to each slave core in row 1 substantially simultaneously. This allows for the core data collection process to be completed more quickly by having multiple slave cores gather their respective core data in parallel. In some embodiments, master core 906 will ping adjacent slave cores to initiate the core data collection. In response, the slave cores can create a collection packet or packets of their own to be passed to other slave cores in processor 900.

When core data collection is initiated at slave cores in row 1, the slave cores in row 1 begin the core data collection process by gathering their respective requested core data. For example, the gathered core data can be added to the data section of collection packets located at each slave core in row 1. Once they have gathered their core data, process 1000 will proceed to step 1008. At step 1008, row 1 of slave cores 902 will pass their gathered core data to the next row of slave cores, for example, row 2. For example, row 1 of slave cores 902 will pass each core's respective collection packet adjacent cores of row 2 of slave cores 902 along core data path 914 as illustrated in FIG. 9.

After the core data from row 1 of slave cores 902 is received by row 2, process 1000 proceeds to step 1010. At step 1010, the requested core data from slave cores in row 2 is gathered and added to the core data received from the cores of row 1. For example, the core data of the cores in row 2 can be added to the core data of the cores in row 1 in the data section of a collection packet. After the core data from row 2 is added to the core data from row 1, process 1000 will proceed to step 1012.

At step 1012, it is determined whether there are more rows of slave cores in processor 900 from which to collect more core data. For example, one or more slave core in the current row of slave cores can ping other rows of slave cores in processor 900 to determine whether cores in the pinged rows have already fulfilled the data collection query. For example, cores in row 1 can ping cores in row 2 to notify cores in row that cores in row have completed their data collection and are ready to pass the collected data to the cores in row 2. Cores in row 2 can respond to the ping when the cores in row 2 are ready to receive the collected data and add their core data to the previously collected data or notify the cores in row 1 that the cores in row 2 have already completed their data request. In alternative embodiments, cores in row 1 can examine flags stored in any appropriate location or examine the header section of the collection packets to determine if any other cores have yet to fulfill their data collection query, as described above with regards to process 500 and process 700 of FIGS. 5 and 7, respectively.

In some embodiments, slave cores can communicate with master core 906 to determine whether there are more cores or rows of cores from which to gather core data. For example, master core 906 can maintain a record of the progress of the data collection. After every core or suitable number of cores completes their data collection, the completed cores communicate with master core 906 to notify master core 906 that the respective slave cores have completed their core data collection. Alternatively, or additionally, a slave core can communicate with master core 906 when a slave core begins to collect its core data to notify master core 906 that the slave core is initiating its data collection process. Thus, master core 906 will have a substantially up-to-date record of the data collection progress. In this embodiments, to determine whether there are more cores from which to collect data at step 1012, a slave core or cores can communicate with master core 906 and based on the data collection record maintained by master core 906, the slave core can determine which cores have or have not begun and/or completed their data collection process.

When it is determined that there are more rows of cores from which to collect data at step 1012, process 1000 proceeds to back to step 1008 to pass the collected core data to another row of cores. For example, a row of cores determined at step 1012 to have yet to begin or complete its core data collection. After the collected core data is passed to the next appropriate row of cores, process 1000 proceeds back to step 1010 to repeat the accumulation of core data and step 1012 to repeat the determination of whether there are more rows of cores from which to collect core data. For example, collection packets can follow core data path 914 through slave cores 902 to gather each core's respective core data while repeating steps 1010 and 1012 as appropriate. When it is determined that there are no other rows of cores in processor 900 from which to collect data, process 1000 proceeds to step 1014.

At step 1014, accumulated core data is dispersed among the columns of the final row of cores. For example, as illustrated by FIG. 9, row 3 is the final row of cores to collect core data. However, the core data is spread among column 1, column 2, column 3, and column 4 of row 3. In a preferred embodiment, this data needs to be accumulated together for efficient transmission back to a system operator. Thus, at step 1014, the core data from each column of cores in the last row of cores in accumulated together. For example, the core at column 1 of row 3 (“core 1,3”) can send its accumulated data to the core at column 2 or row 3 (“core 2,3”). Core 2,3 can then accumulate the accumulated data from core 1,3 with its own accumulated data. This process can repeat until the accumulated data reaches core 4,3. For example, the accumulated core data can follow path 914 through row 3. When the accumulated data reaches core 4,3, all the queried data from each of slave cores 902 has been accumulated together into a single location. Once all the data has been accumulated into a single location, process 1000 can proceed to step 1016.

At step 1016, the core that contains the total accumulated core data will pass the accumulated data from the last row of cores to master core 906. For example, core 4,3 will pass the complete accumulated core data from core 4,3 to master core 906 along core data path 914 (e.g., through every core in column 4) until the complete accumulated core data reaches master core 906. When the accumulated core data reaches master core 906, process 1000 will proceed to step 1018.

At step 1018, master core 906 transmits the compiled accumulated core data back to the system operator that initiated the core data query or any other suitable element. For example, the compiled core data exits master core 906 and processor 900, in any suitable form, via output 912. The data can be transmitted to, for example, device interface 108 of FIG. 1 for transmission the system operator and/or memory 112 of FIG. 1 for later use.

In some embodiments, the query initiated by a system operator would require that master core 906 include its core data in addition to the slave core data. In such an embodiment, the master core 906 will add its core data during or after any suitable step of process 1000. For example, master core 906 can add its core data when it receives the compiled slave core data after step 1016.

It should be noted that process 1000 for collecting core data in parallel (e.g., row-by-row as opposed to core-by-core) is shown being completed on a multi-core processor in a master/slave configuration purely for illustrative purposes. Process 1000 can be applied to a multi-core processor in a mesh configuration, such as processor 300 of FIG. 3, as well. For example, core data can be collected in parallel without the use of a master core. Furthermore, process 1000 can be combined in any suitable manner with process 500 and/or process 700. For example, processor 900 can include a memory substantially similar to memory 606 of FIG. 6. In such an embodiment, process 1000 can be combined with any suitable step of process 700 to utilize the memory in the core data collection process.

In practice, one or more stages shown in process 1000 may be combined with other stages, performed in any suitable order, performed in parallel (e.g., simultaneously or substantially simultaneously), or removed. For example, cores can accumulate the requested core data at the current row of cores with data from the previous row of cores at step 1010 and accumulate data from columns of cores at step 1014 substantially simultaneously. Process 1000 may be implemented using any suitable combination of hardware and/or software in any suitable fashion. Furthermore, process 1000 is not limited to progressing through processor 900 row-by-row. Process 1000 can be completed by progressing through processor 900 in any suitable manner, for example, column-by-column.

It should be noted that the multi-core processor configurations shown herein are depicted purely for illustrative purposes. The processes disclosed herein for collecting core data from multi-core processors can be equally applied to multi-core processors configured in any suitable manner with any suitable number of cores.

The invention may be embodied in other specific forms without departing from the spirit or essential characteristics thereof. For example, the invention is not limited to using a single collection packet when querying a processor. For example, any number of collection packets less than the number of cores in a multi-core processor can be used to execute a particular query without departing from the scope of the invention. The foregoing embodiments are therefore to be considered in all respects illustrative, rather than limiting of the invention.

What is claimed is:

1. A method for extracting information from a plurality of cores in a multi-core processor, the method comprising:
receiving a request from a data collection element to begin collecting core data from the multi-core processor;
delivering a first collection instruction to a first core of the plurality of cores in the multi-core processor;
extracting core data from the first core in response to the first collection instruction;
passing a second collection instruction from the first core to a second core of the plurality of cores;
extracting core data from the second core in response to the second collection instruction;
accumulating the core data from the second core with the core data from the first core; and
transmitting the accumulated core data to the data collection element.

2. The method of claim 1, further comprising, in response to the request, accumulating core data from remaining cores of the plurality of cores prior to transmitting the accumulated core data to the data collection element.

3. The method of claim 1, wherein the passed second collection instruction includes the extracted core data from the first core.

4. The method of claim 1, wherein the first collection instruction is the request.

5. The method of claim 1, wherein the second collection instruction is the first collection instruction.

6. The method of claim 1, further comprising generating the first collection instruction based on the request, in response to receiving the request.

7. The method of claim 1, further comprising:
determining that the second core is a core of the plurality of cores that contains data requested by the data collection element, and
wherein the passing of the second collection instruction is in response to the determining.

8. The method of claim 1, wherein accumulating further comprises, in response to the second collection instruction, combining a core data value associated with a respective core to a core data value associated with another core.

9. The method of claim 1, wherein accumulating further comprises accumulating the core data into a packet.

10. The method of claim 9, wherein the packet includes the second collection instruction and passing comprises passing the packet to the second core.

11. The method of claim 9, wherein the packet includes a header section and a data section, and wherein the header section of the packet includes the second collection instruction.

12. The method of claim 1, comprising passing by the first core, a third collection instruction to a third core of the plurality of cores at substantially the same time as the first core passes the second collection instruction to the second core.

13. The method of claim 12, further comprising receiving results of the second and the third collection instructions; and
accumulating comprises accumulating the results.

14. The method of claim 1, further comprising storing core data from a respective core in a memory after the core data is extracted from the respective core in response to a corresponding collection instruction.

15. The method of claim 14, wherein the accumulating comprises accumulating core data stored in the memory.

16. The method of claim 15, wherein the core data from each respective core is stored in memory locations associated with the respective cores, and wherein the accumulating further comprises accumulating core data from each of the respective memory locations.

17. The method of claim 15, wherein the accumulated core data is stored in a specified memory location in the memory, and
wherein the accumulating further comprises adding core data extracted from a core to previously accumulated core data stored in the memory as core data is extracted from each respective core.

18. The method of claim 1, wherein the core data includes packet counter values that are associated with a number of previously received packets that were processed by a respective core of the plurality of cores.

19. The method of claim 1, wherein the first core and the second core are adjacent cores.

20. The method of claim 1, wherein the multi-core processor is part of a network device.

21. A multi-core processor comprising:
at least first and second cores;
an interface configured to:
receive a request from a data collection element to begin collecting core data from the multi-core processor,
deliver a first collection instruction to the first core of the multi-core processor, and
transmit accumulated core data to the data collection element;
wherein the first core is configured to:
extract core data from the first core in response to the first collection instruction, and
pass a second collection instruction to a second core of the plurality of cores; and
the second core is configured to:
extract core data from the second core in response to the second collection instruction, and
accumulate the core data from the second core with the core data from the first core.

22. The multi-core processor of claim 21, further comprising:
a memory configured to:
store core data from a respective core after the core data is extracted from the respective core.

23. The multi-core processor of claim 21, wherein the request received from the data collection element is the first collection instruction.

24. The multi-core processor of claim 21, wherein the passed second collection instruction includes the extracted core data from the first core.

25. The multi-core processor claim 21, wherein the first core of the plurality of cores is further configured to create the first collection instruction in response to receiving the request from the data collection element.

26. A computer readable medium storing computer executable instructions, which, when executed by a processor, cause the processor to carryout a method for extracting information from a plurality of cores in a multi-core processor, the computer readable medium comprising:
receiving a request from a data collection element to begin collecting core data from the multi-core processor;
delivering a first collection to a first core of the plurality of cores in the multi-core processor;
extracting core data from the first core in response to the first collection instruction;
passing a second collection instruction to a second core of the plurality of cores;
extracting core data from the second core in response to the second collection instruction;
accumulating the core data from the second core with the core data from the first core; and
transmitting the accumulated core data to the data collection element.

27. The computer readable medium of claim 26, further comprising:
analyzing the received request from the data collection element to determine the request is a collection packet.

28. A method for requesting core data from a plurality of cores in a multi-core processor, the method comprising:
generating a request with instructions to begin collection of core data from selected cores of the plurality of cores using a collection packet; and
transmitting the request to the multi-core processor; and
receiving a response to the request from the multi-core processor including data accumulated from the plurality of cores.

29. The method of claim 28, wherein the request includes instructions to create the collection packet upon receipt at the multi-core processor.

30. The method of claim 28, wherein the request is the collection packet.

31. The method of claim 28, wherein the request includes instructions regarding the data collection path of the collection packet through the multi-core processor.

32. The method of claim 27, wherein the received response is the collection packet.
